(19) United States
(12) Patent Application Publication
(10) Pub. No.: US 2015/0373398 A1
(43) Pub. Date: Dec. 24, 2015

(54) RECORDING AND SHARING TELEVISED CONTENT

(71) Applicant: International Business Machines Corporation, Armonk, NY (US)

(72) Inventors: BARRY A. KRITT, Atlantic Beach, NC (US); SARBAJIT K. RAKSHIT, Kolkata (IN)

(21) Appl. No.: 14/307,592

(22) Filed: Jun. 18, 2014

(51) Int. Cl. H04N 21/433; H04N 21/472

(52) U.S. Cl. CPC H04N 21/4334; H04N 21/47214

(57) ABSTRACT

A method, system, and computer program product for recording and sharing televised content are provided in the illustrative embodiments. The televised content is selected at a first device associated with a first subscriber. A determination is made that a second device associated with a second subscriber should be used for recording the televised content. The first device and the second device are configured by a content provider to not share any recorded content. A request to record the televised content at the second device is sent from the first device to the second device. The second device is caused to create a recording of the televised content at the second device responsive to the request. The second device is caused to grant the first subscriber access to the recording responsive to the request. A transmission of the recording is received at the first device from the second device.

### TECHNICAL FIELD

The present invention relates generally to a method, system, and computer program product for using televised programming. More particularly, the present invention relates to a method, system, and computer program product for recording and sharing televised content.

### BACKGROUND

Televised content includes the programs or content transmitted for viewing on devices such as a television. Typically, a content owner produces or owns the rights to certain content. The content owner supplies the content to a service provider for televising to the subscriber. The service provider provides a distribution network and/or a service, using which the content is delivered or televised to a subscriber in the form of televised content.

A variety of devices is available for recording the televised content. For example, a set-top box (STB) is a device that interfaces with the service provider's network or service, receives the televised content, and makes the televised content available for presentation, typically on a television.

Modern STBs are capable of recording or storing the televised content for future viewing. While some STBs are service provider-owned or supplied, many other third-party devices or subscriber-owned devices are also available with similar capabilities for recording televised content. All such devices are collectively referred to herein as STBs.

A subscriber account or person (subscriber) is associated with the STB. The service provider identifies the subscriber, and allows the subscriber access to such content as an agreement with the subscriber provides. Such content is referred to as subscribed content. The televised content to a subscriber includes the subscriber's subscribed content.

An STB presently includes one or more data storage devices, such as one or more hard disk drives or solid-state memories, to record and store the televised content. From the televised content an STB presently can record only the subscribed content of the subscriber.

### SUMMARY

The illustrative embodiments provide a method, system, and computer program product for recording and sharing televised content. An embodiment includes a method for recording and sharing televised content. The embodiment selects, at a first device associated with a first subscriber, the televised content. The embodiment determines that a second device associated with a second subscriber should be used for recording the televised content, wherein the first device and the second device are configured by a content provider to not share any recorded content. The embodiment sends, from the first device to the second device, a first request to record the televised content at the second device. The embodiment causes, responsive to the first request, the second device to create a recording of the televised content at the second device. The embodiment causes, responsive to the first request, the second device to grant the first subscriber access to the recording. The embodiment receives, at the first device, a transmission of the recording from the second device.

Another embodiment includes a computer usable program product comprising a computer readable storage device including computer usable code for recording and sharing televised content. The embodiment further includes computer usable code for selecting, at a first device associated with a first subscriber, the televised content. The embodiment further includes computer usable code for determining that a second device associated with a second subscriber should be used for recording the televised content, wherein the first device and the second device are configured by a content provider to not share any recorded content. The embodiment further includes computer usable code for sending, from the first device to the second device, a first request to record the televised content at the second device. The embodiment further includes computer usable code for causing, responsive to the first request, the second device to create a recording of the televised content at the second device. The embodiment further includes computer usable code for causing, responsive to the first request, the second device to grant the first subscriber access to the recording. The embodiment further includes computer usable code for receiving, at the first device, a transmission of the recording from the second device.

Another embodiment includes a system for recording and sharing televised content. The embodiment further includes a storage device including a storage medium, wherein the storage device stores computer usable program code. The embodiment further includes a processor, wherein the processor executes the computer usable program code. The embodiment further includes computer usable code for selecting, at a first device associated with a first subscriber, the televised content. The embodiment further includes computer usable code for determining that a second device associated with a second subscriber should be used for recording the televised content, wherein the first device and the second device are configured by a content provider to not share any recorded content. The embodiment further includes computer usable code for sending, from the first device to the second device, a first request to record the televised content at the second device. The embodiment further includes computer usable code for causing, responsive to the first request, the second device to create a recording of the televised content at the second device. The embodiment further includes computer usable code for causing, responsive to the first request, the second device to grant the first subscriber access to the recording. The embodiment further includes computer usable code for receiving, at the first device, a transmission of the recording from the second device.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example view of a programming guide from which recording and sharing televised content can be accomplished in accordance with an illustrative embodiment;

FIG. 4 depicts a configuration for recording and sharing televised content in accordance with an illustrative embodiment;

FIG. 5 depicts a flowchart of an example process for recording and sharing televised content in accordance with an illustrative embodiment;

FIG. 6 depicts a flowchart of another process that can be used in recording and sharing televised content in accordance with an illustrative embodiment; and

FIG. 7 depicts a flowchart of an example process for recording and sharing televised content in accordance with an illustrative embodiment.

### DETAILED DESCRIPTION

Generally, the service provider provides a schedule of the television programming in the form of a programming guide. The subscriber determines whether a particular televised content appearing at a date, time, and duration in the programming guide is of interest. If the televised content is of interest, the subscriber instructs the subscriber's STB to record that televised content. The subscriber's STB records the televised content. The subscriber accesses the recording and plays back the recorded televised content.

The illustrative embodiments recognize that presently, the subscriber is limited in the amount of televised content the STB can record by the size of the storage device used by the STB. For example, recording of a sixty minute program in standard definition (SD) uses approximately 1 Gigabytes (GB) of storage space in the storage device of the STB. Recording the same program in high definition (HD) uses four to five times as much storage space. Thus, the total available storage space on the STB's storage device becomes a limiting factor on the amount of televised content the subscriber can record on the subscriber's STB.

The illustrative embodiments used to describe the invention generally address and solve the above-described problems and other problems related to recording television programming. The illustrative embodiments provide a method, system, and computer program product for recording and sharing televised content.

Assume that person P1 and person P2 are social acquaintances. For example, P1 and P2 may be family members, personal friends, colleagues, or persons otherwise connected through social media.

The illustrative embodiments recognize that different persons may select different sets of televised content for recording. These different sets of televised contents may or may not overlap. For example, person P1 may review the programming guide available to P1 and decide to record televised content C1, C2, and C3. Person P2 may be interested in recording televised content C3 and C4.

An embodiment allows P1 to see that P2 has recorded, is recording, or has scheduled to record televised content C3 in which P1 is interested. The embodiment requests a device associated with P2, on behalf of P1, to record, save, share, or a combination thereof, a televised content C3.

In some cases P1 may want to record a televised content but may be unable to do so given inadequate amount of storage space or other limitation on P1's STB. Another embodiment requests a device associated with P2, on behalf of P1, to record, save, share, or a combination thereof, a televised content, even when P2 may not have an interest in C3, may not have recorded C3, or may not have planned to record C3.

These example scenarios are described using only two example persons for the clarity of the description and not to imply any limitation on the illustrative embodiments. Any number of persons can similarly collaboratively record and share televised content to overcome the space and other limitations of their respective STBs, subscriptions, or both.

For example, P1 may be a subscriber of service provider S1, and P2 may be a subscriber of service provider S2. S1 may not carry televised content C3, but S2 might. An embodiment requests P2's STB to record C3. P1 can later go over to P2's house, and view the recording of televised content C3, thereby overcoming a limitation in P1's subscription.

Presently a recording of C3 made on P2's STB is available for viewing on a device such as a smartphone, associated with P2 but not on a device associated with P1. Another embodiment passes P1's authentication information along with the request to record televised content C3 to the STB of P2. The STB of P2 requests an authorization from service provider S2 to share televised content C3 with P1. When the STB of P2 receives the authorization from service provider S2, an embodiment configures the STB of P2 to transmit C3 to the STB of P1 or another device associated with P1.

When P1 and P2 both subscribe to the same service provider, the service provider can evaluate whether P1 can be authorized to share P2's recorded content. When P1 and P2 each subscribes to a different service provider, the different service providers can collaborate, such as via back-channel communication between the service providers, to determine whether P1 can be authorized to share P2's recorded content.

The illustrative embodiments are described with respect to certain scenarios of recording and sharing televised contents, types of content, subscriptions, television programming, back-channel communications, rules, policies, algorithms, data processing systems, environments, components, and applications only as examples. Any specific manifestations of such artifacts are not intended to be limiting to the invention. Any suitable manifestation of data processing systems, environments, components, and applications can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

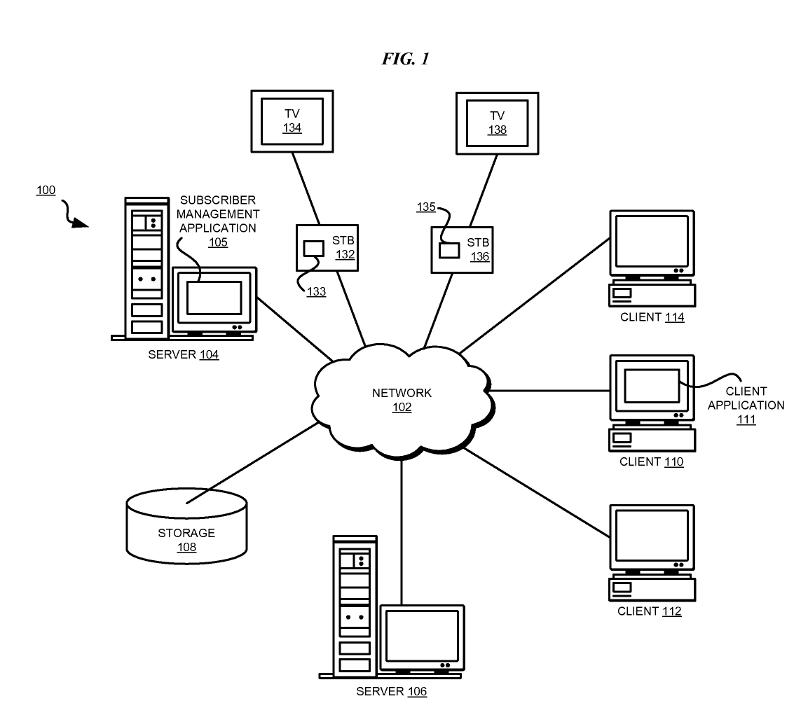

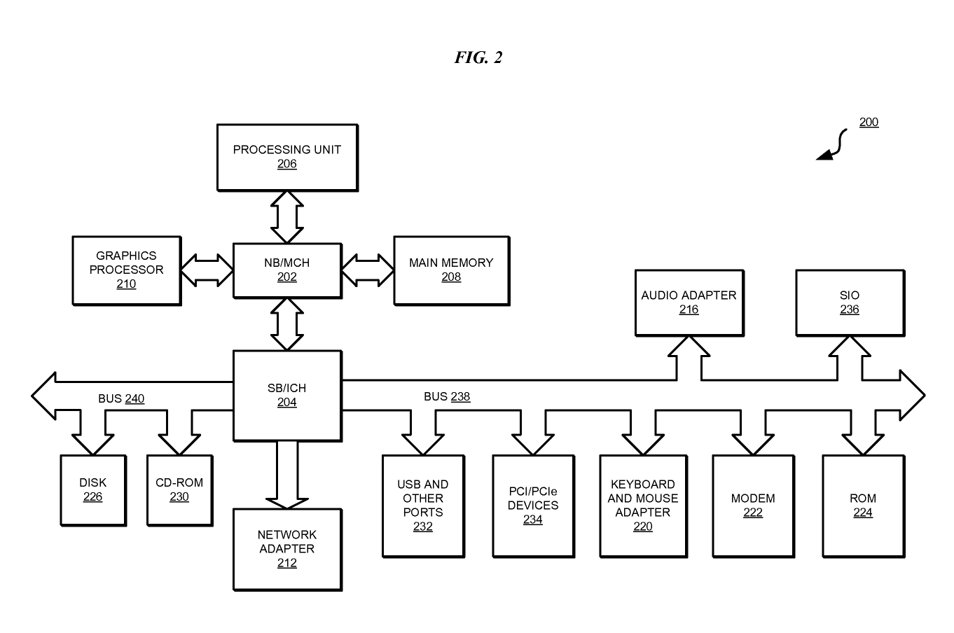

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Only as an example, and without implying any limitation to such architecture, FIG. 1 depicts certain components that are useable in an embodiment. For example, assume that an instance of an STB according to an embodiment, STB 132, is associated with a subscriber or non-subscriber to receive televised content. STB 132 executes application 133, which implements an embodiment described herein. STB 132 is configured to present the televised content on television (TV) 134 or another device (not shown) capable of presenting televised content. A subscriber is a person or entity who subscribes to a service provider for the purpose of receiving televised content or is otherwise authorized to receive the televised content. A non-subscriber is a person or entity who subscribes to a different service provider, or does not subscribe to any service provider for a similar purpose. Another instance of an STB according to an embodiment, STB 136, is associated with another subscriber or non-subscriber to receive televised content. STB 136 executes application 135, which implements an embodiment described herein. STB 136 is configured to present the televised content on TV 138 or another device (not shown) capable of presenting televised content. For example, client application 111 in client 110 is configurable to present televised content, configure STB 136, communicate with STB 132, plan or review recordings on STB 136, STB 132, or both. Server 104 may be a server associated with a service provider, and includes application 105. Application 105 is a subscriber management application and is configured to perform authentication of the service provider's subscribers, communicate over a back-channel with other service providers, configure or allow configuring STBs, such as STB 132 or 136, and other subscriber-related functions for distributing and managing televised content to subscribers and non-subscribers.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114, or systems 132, 136, or 142 in FIG. 1, or another type of device in which computer usable program code or instructions implementing the processes may be located for the illustrative embodiments. Data processing system 200 is also representative of a device, such as an embedded system (not shown) in vehicle 132 in FIG. 1 on which application 133 executes, or device 136 in FIG. 1, in which computer usable program code or instructions implementing the processes of the illustrative embodiments may be located for the illustrative embodiments. Data processing system 200 is also representative of an embedded, removable, or mobile computing device, such as an example implementation of STB 132, TV 134, or a combination thereof, STB 136, TV 138, or a combination thereof, in FIG. 1 in which computer usable program code or instructions implementing the processes of the illustrative embodiments may be located. Data processing system 200 is described as a computer only as an example, without being limited thereto. Implementations in the form of STBs, TVs, or their combinations in FIG. 1 may modify data processing system 200 and even eliminate certain depicted components there from without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCl/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCl/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as applications 105, 111, 133, and 135 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

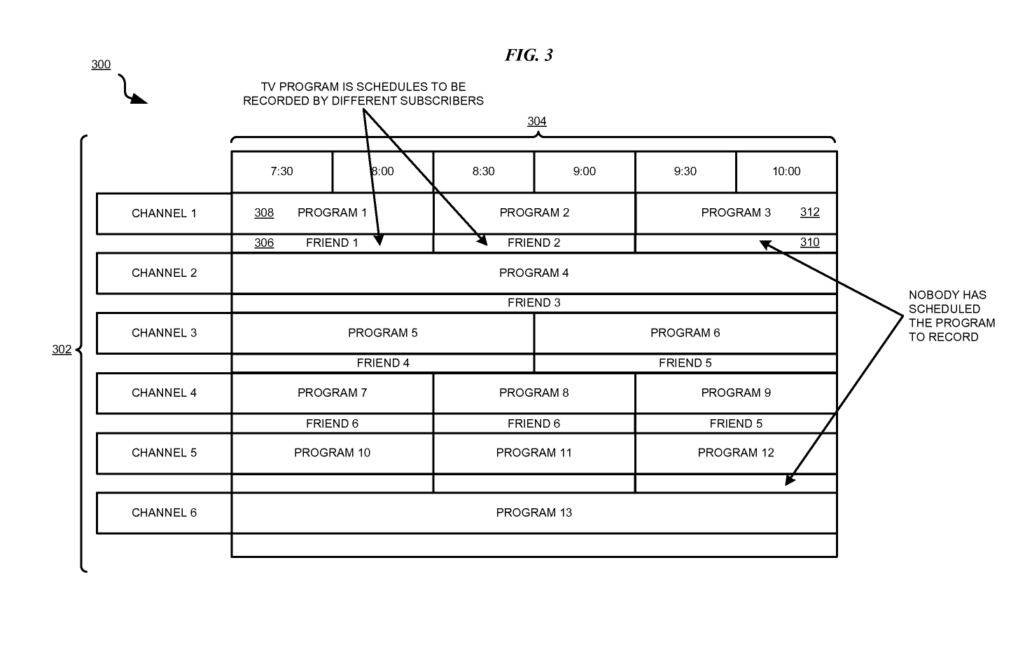

With reference to FIG. 3, this figure depicts a block diagram of an example view of a programming guide from which recording and sharing televised content can be accomplished in accordance with an illustrative embodiment. Guide 300 can be presented via STB 132 on TV 134 in FIG. 1. The information for guide 300 is provided as a part of televised content from a service provider, such as a service provider associated with server 104 in FIG. 1.

Guide 300 depicts channel lineup 302 and times 304. Guide 300 presents a grid organization of the programs scheduled on the various channels in channel lineup 302 at times 304.

According to an embodiment, such as an embodiment implemented in STB 132 as application 133 or in STB 136 as application 135 in FIG. 1, additional information is presented in guide 300. The application presents a field in association with a program presented in the grid of guide 300. For example, field 306 is shown associated with block 308, which shows that “Program 1” appears on “channel 1” from 7:30-8:30. Other fields are similarly shown associated with other programs in the grid of guide 300 in a similar manner.

Field 306 is populated with information about who, in a group of individuals or entities known to the viewer, is recording the program of block 308. Within the scope of the illustrative embodiments, a group comprises one or more members. For example, in one embodiment, the application allows the viewer to login to a social networking website and select individuals or entities whose recording settings the viewer is interested in seeing. In another example embodiment, the application allows the viewer to input information sufficient to identify certain individuals or entities whose recording settings the viewer is interested in seeing. Generally, the application can be configured to select such individuals in these and other similarly purposed manner within the scope of the illustrative embodiments.

An embodiment further enables the application to receive, collect, or otherwise determine information sufficient to communicate with STBs associated with the selected individuals or entities who are not sharing the same subscription, such as under a common or single subscriber account with a common or single service provider. In one example embodiment, the viewer selects a social acquaintance from the social networking website, specifies a zip code where the acquaintance's STB is located. The application presents a list of matching individuals in that zip code to allow the user to further narrow down to the specific individual or entity from the list. Once narrowed to the individual or entity that is the acquaintance, the application determines the service provider, the Internet protocol address (IP address) or other manner of addressing the STB of the individual or entity, and the like. With such information, the application is able to present the information depicted in field 306 in the depicted form or other suitable form.

In another example embodiment, the viewer specifies only the information sufficient to identify and communicate with another individual or entity's STB. The application determines the service provider, the IP address or other manner of addressing the STB of the individual or entity, and the like. Optionally, the viewer can also specify how that other individual or entity is to be represented in field 306. With such information, the application is able to present the information depicted in field 306 in the depicted form or other suitable form.

In another example embodiment, the viewer inputs a name or other identifying information of an individual or entity, with whose STB the viewer wishes to communicate. The application, through questions and answers, form-filling, searching, or other suitable method, collects information from the viewer to locate the specific individual or entity's STB. With such information, the application is able to present the information depicted in field 306 in the depicted form or other suitable form.

Note that the particular manner of presenting the field or the information contained therein is not intended to be limiting on the illustrative embodiments. Other ways of communicating the same information to a viewer will be apparent from this disclosure and the same are contemplated within the scope of the illustrative embodiments. For example, field 306 and the information therein can be communicated to the viewer by color coding block 308, such that block 308 is colored in different colors or shades to represent the different individuals or entities who's STBs have been configured for access by the application.

In the depicted example, field 306 indicates that “Friend 1” of the viewer has recorded, is recording, or has configured his/her/their STB to record “Program 1” of block 308. Other blocks and their associated fields similarly identify which program has been recorded, is presently recording, or has been scheduled to be recorded by a member of the group whose STBs are accessible to the viewer. In a similar manner, where a field associated with a block does not include any indication of recording activity, such as field 310 associated with block 312, the viewer's STB can perform other functions, including but not limited to allowing the viewer to record that program or televised content on the viewer's STB.

When the viewer's STB has insufficient space to record “Program 3” of block 312, or for other reasons, the viewer may want a member of the group described above to record that televised content. For example, according to one embodiment, the application in the viewer's STB accepts a command from the viewer to select a televised content or program, and a member of the group. The application prepares a message for the STB associated with that member of the group. The application sends the message—a request—to the member's STB to record the specified televised content.

Note that the same televised content, e.g., “Program 3” might appear on a channel other than channel 1 on the member's STB. The request identifies the program using a parameter associated with the televised content, e.g., a title, a license information, an Internet Movie Database (IMDB) or other repository-based identifier, a combination of production or distribution information attributes, or other parameter usable to uniquely identify the program in a given program guide.

Given sufficient access permissions, the application according to an embodiment may also send a recording command to the selected group member's STB, such that the member's STB can commence the recording of the televised content when scheduled. Furthermore, the televised content identified in the request need not be accessible to the viewer according to the viewer's subscription but has to be accessible to the selected group member according to the selected group member's subscription, as different from the viewer's subscription.

In one embodiment, the application further includes information sufficient to identify the viewer, the viewer's subscription, the viewer's service provider, or a combination thereof (requestor information) to the group member's STB. Such information is usable at the group member's STB not only to allow the group member, but also a content provider of the requested televised content to control whether the recording should be permitted.

For example, an embodiment implemented in the group member's STB and executing as an application therein, presents the requestor information to the group member. The group member thus knows that someone else has requested a recording on the group member's STB. Another embodiment allows the group member's STB to transmit the requestor information to the group member's service provider, who then decides and indicates to the group member's STB whether to permit the recording for the benefit of the viewer. The group member's service provider may make such a determination, for example, by communicating with the viewer's service provider.

In another embodiment, the application further includes information sufficient to indicate a length of time for which the recording is to be preserved, conditions on erasing the recording, and other similarly purposed parameters (collectively, preservation parameters). Such a preservation parameter is usable at the group member's STB to prevent accidental erasure of the requested recording, prompt the group member before deleting that the viewer has requested to preserve the recording, e.g., until the viewer has viewed the recording, to perform other similarly purposed functions.

As an example, because of a preservation parameter, the group member may chose to move the recording to a cloud-based storage instead of deleting from the group member's STB. The application on the group member's STB redirects the viewer's STB to the cloud storage at the time of the moving or when the viewer's STB requests the recording.

Where a group member has recorded, is recording, or has scheduled to record a televised content, the viewer can send a different request to gain access to such recording. For example, field 306 shows that “Friend 1” is recording “Program 1” of block 308. According to an embodiment, the application in the viewer's STB configures a request identifying the televised content, the requestor information, and any preservation parameters in the manner described above. This request requests a group member's STB access to a recording already existing or planned thereon.

In one embodiment, a request to access a recording is distinct from a request to create a recording described earlier. In another embodiment, the requests remain structurally the same but are distinguished by a value of a parameter in the request structure, e.g., a flag.

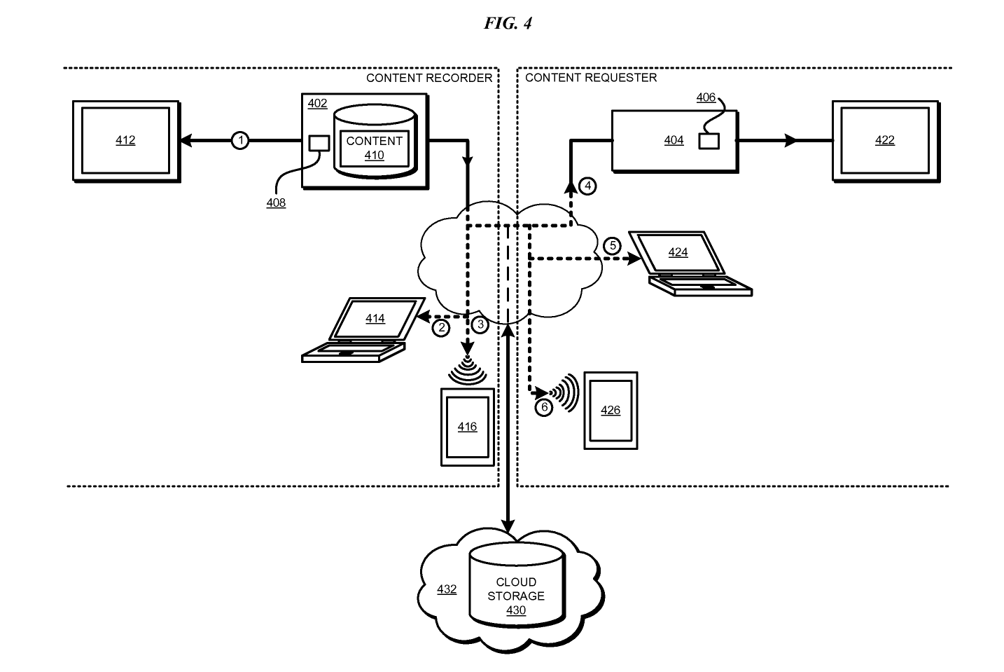

With reference to FIG. 4, this figure depicts a configuration for recording and sharing televised content in accordance with an illustrative embodiment. STB 402 is associated with a selected member from a group of acquaintances (labeled, content recorder in FIG. 4) as described with respect to FIG. 3. STB 404 is associated with a viewer (labeled, content requestor in FIG. 4) who requests recording or access to a recording on STB 402 as described with respect to FIG. 3.

In the manner described with respect to FIG. 3, STB 404 via application 406 therein, sends a request to application 408 in STB 402, to either record or gain access to content 410. Content 410 is a recording of a televised content, e.g., a recording of “Program 1” in the example in FIG. 3.

Presently, content 410 is available to the devices associated with the content recorder, under content recorder's subscription. For example, presently, once content 410 is available at STB 402, content recorder's TV 412 can access content 410 over communication path “1”, content recorder's device such as computer 414 can access content 410 over communication path “2”, or content recorder's table or smartphone 416 can access content 410 over communication path “3”.

Content 410 is presently not accessible on content requestor's TV 422, content requestor's device such as computer 424, or content requestor's table or smartphone 426. By using an embodiment, application 402 enables content 410 such that content 410 becomes accessible on content requestor's TV 422 via communication path “4”, content requestor's device such as computer 424 via communication path “5”, or content requestor's table or smartphone 426 via communication path “6”.

By using an embodiment, application 408 can also move content 410 to cloud storage 430 in cloud architecture 432, over communication path “7”. Once stored in cloud storage 430, content 410 can remain accessible to STB 404, TV 422, computer 424, and tablet or smartphone 426 over the combination of paths “7” and “4”, “7” and “5”, and “7” and “6”, respectively.

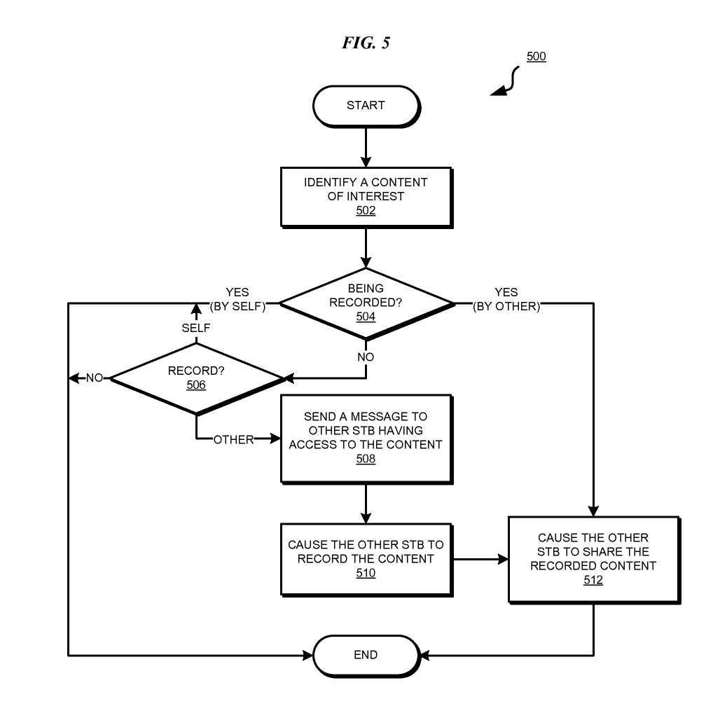

With reference to FIG. 5, this figure depicts a flowchart of an example process for recording and sharing televised content in accordance with an illustrative embodiment. Process 500 can be implemented in application 406 in FIG. 4.

The application identifies a televised content of interest (block 502). For example, a viewer indicates interest in a televised content to the application by selecting that content from a programming guide.

The application determines whether the televised content is being recorded (block 504). For example, the application determines whether the televised content has been recorded, is currently recording, or is scheduled to be recorded.

If the application determines that the televised content is being recorded by the STB associated with the application (“Yes-by self” path of block 504), the application ends process 500 thereafter. If the application determines that the televised content is being recorded by an STB associated with a member of a group of the viewer's acquaintances, e.g., STB 402 in FIG. 4, (“Yes-by other” path of block 504), the application proceeds to block 512.

If the application determines that the televised content is not being recorded by the STB associated with the application or by the STB associated with the application (“No” path of block 504), the application determines whether the televised content should be recorded (block 506). For example, the application determines whether the viewer's expressed interest by selecting the televised content from the programming guide is for recording the televised content.

If the application determines that the televised content should be recorded by the STB of the viewer (path not shown), the application commences a prior-art recording action on the STB associated with the application.

If the application determines that the televised content should not be recorded (“No” path of block 506), the application If the application determines that the televised content should be recorded by an STB associated with a member of a group of acquaintances (“Other” path of block 506), the application sends a message to the STB of such member that has access to the televised content of interest.

The application causes the member's STB to record the televised content (block 510). The application causes the member's STB to share access to the recording of the televised content (block 512). The application ends process 500 thereafter.

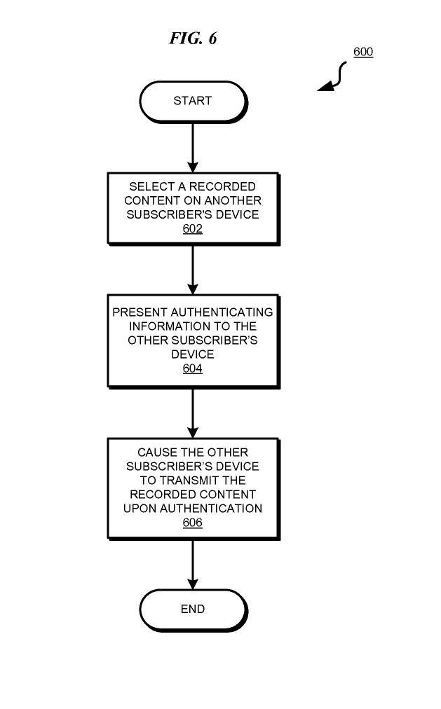

With reference to FIG. 6, this figure depicts a flowchart of another process that can be used in recording and sharing televised content in accordance with an illustrative embodiment. Process 600 can be implemented in application 406 in FIG. 4.

The application selects a televised content that has been recorded, is being recorded, or is scheduled to be recorded on another subscriber's STB, such as on STB 402 in FIG. 4 (block 602). The application presents authenticating information, such as the requestor parameters described earlier, to the other subscriber's STB (block 604).

The application causes the other subscriber's STB to transmit, upon authentication, the recorded televised content from the other subscriber's STB to the STB of the requestor subscriber, e.g., STB 404 in FIG. 4, or another device associated with the requestor, e.g., computer 424 or portable computing device 426 in FIG. 4 (block 606). The application ends process 600 thereafter.

As an example, in one embodiment, the application, by presenting the requestor parameters to the other subscriber's STB, causes the other subscriber's STB to transmit the requestor parameters to a content provider, such as a service provider of the other subscriber. The content provider determines whether to permit the recording, permit the sharing of the recording, or the combination thereof, for the benefit of the requestor.

The content provider's approval of the authentication results in the operation of block 606. The content provider's denial of the authentication results in bypassing (not shown) or non-performance of the operation of block 606. In another embodiment, a similar approval or denial is performed by the other subscriber associated with the other subscriber's STB.

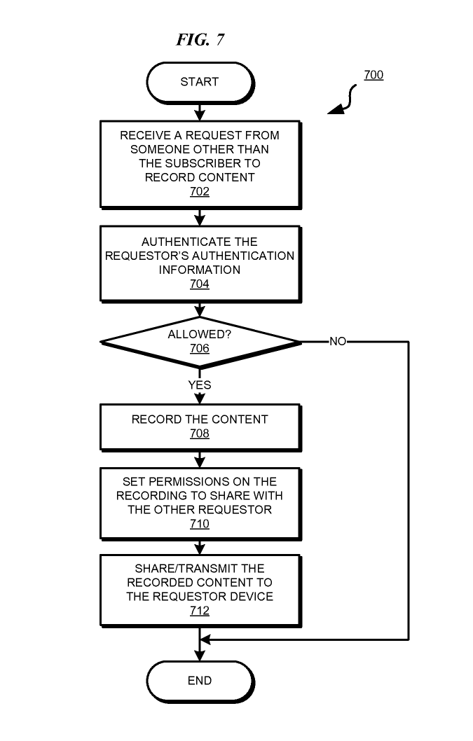

With reference to FIG. 7, this figure depicts a flowchart of an example process for recording and sharing televised content in accordance with an illustrative embodiment. Process 700 can be implemented in a STB receiving a request for recording, e.g., in application 408 in STB 402 in FIG. 4, from another subscriber, e.g., from STB 404 at the content requestor in FIG. 4, such as from process 500 in FIG. 5.

The application receives a request for recording a televised content, the request being from someone not associated with or covered under a subscriber account of the STB where the application is executing (block 702). The application authenticates the requestor's authentication information, e.g., requestor parameters (block 704).

The application determines whether the requestor is allowed to cause the recording, to have access to the recording, or both (block 706). If the application determines that the requestor is not allowed (“No” path of block 706), the application ends process 700 thereafter. Optionally, the application may return (not shown) an error or failure message to the requestor.

If the application determines that the requestor is allowed (“Yes” path of block 706), the application records the requested televised content (block 708). The application sets one or more permissions on the recording to enable sharing of the recording with the requestor (block 710). The application shares or transmits the recorded televised content to a device associated with the requestor (block 712). The application ends process 700 thereafter.

Thus, a computer implemented method, system or apparatus, and computer program product are provided in the illustrative embodiments for recording and sharing televised content.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for recording and sharing televised content, the method comprising:
selecting, at a first device associated with a first subscriber, the televised content;
determining that a second device associated with a second subscriber should be used for recording the televised content, wherein the first device and the second device are configured by a content provider to not share any recorded content;
sending, from the first device to the second device, a first request to record the televised content at the second device;
causing, responsive to the first request, the second device to create a recording of the televised content at the second device;
causing, responsive to the first request, the second device to grant the first subscriber access to the recording; and
receiving, at the first device, a transmission of the recording from the second device.

2. The method of claim 1, further comprising:
selecting, at a first device associated with a first subscriber, a second televised content;
determining that the second device associated with the second subscriber contains a second recording of the second televised content;
sending, from the first device to the second device, a second request to access the second recording at the second device;
causing, responsive to the second request, the second device to grant the first subscriber access to the second recording; and
receiving, at the first device, a transmission of the second recording from the second device.

3. The method of claim 1, further comprising:
providing, in the first request identifying information about the first subscriber, wherein the recording is created responsive to a content provider authenticating the first subscriber using the identifying information and the content provider allowing the recording for sharing with the first subscriber.

4. The method of claim 3, wherein the content provider authenticates the first subscriber by communicating the identifying information to a service provider of the first subscriber.

5. The method of claim 1, further comprising:
sending, from the first device to the second device, a second request to access the recording from the first device.

6. The method of claim 5, wherein the second request to access causes the recording to become accessible at a third device associated with the first subscriber.

7. The method of claim 5, wherein the first and the second request are a single combined request.

8. The method of claim 1, further comprising:
determining that the second subscriber has already scheduled to record the televised content.

9. The method of claim 1, further comprising:
selecting a set of acquaintances of the first subscriber, wherein the second subscriber is a member of the set of acquaintances.

10. The method of claim 9, further comprising:
selecting the second subscriber from a social network of the first subscriber.

11. The method of claim 9, further comprising:
inputting an information, the information being usable to identify the second device and the second subscriber.

12. The method of claim 9, further comprising:
depicting on a guide a correspondence between a member of the set of acquaintances and a set of programs, the set of programs comprising the televised content, wherein the second subscriber is depicted corresponding to the televised content on the guide, and wherein the determining that the second device should be used automatically results from selecting the televised content from the guide.

13. The method of claim 1, wherein the first device is configured to operate with a first content provider and the second device is configured to operate with a second content provider.

14. A computer usable program product comprising a computer readable storage device including computer usable code for recording and sharing televised content, the computer usable code comprising:
computer usable code for selecting, at a first device associated with a first subscriber, the televised content;
computer usable code for determining that a second device associated with a second subscriber should be used for recording the televised content, wherein the first device and the second device are configured by a content provider to not share any recorded content;
computer usable code for sending, from the first device to the second device, a first request to record the televised content at the second device;
computer usable code for causing, responsive to the first request, the second device to create a recording of the televised content at the second device;
computer usable code for causing, responsive to the first request, the second device to grant the first subscriber access to the recording; and
computer usable code for receiving, at the first device, a transmission of the recording from the second device.

15. The computer usable program product of claim 14, further comprising:
computer usable code for selecting, at a first device associated with a first subscriber, a second televised content;
computer usable code for determining that the second device associated with the second subscriber contains a second recording of the second televised content;
computer usable code for sending, from the first device to the second device, a second request to access the second recording at the second device;
computer usable code for causing, responsive to the second request, the second device to grant the first subscriber access to the second recording; and
computer usable code for receiving, at the first device, a transmission of the second recording from the second device.

16. The computer usable program product of claim 14, further comprising:
computer usable code for providing, in the first request identifying information about the first subscriber, wherein the recording is created responsive to a content provider authenticating the first subscriber using the identifying information and the content provider allowing the recording for sharing with the first subscriber.

17. The computer usable program product of claim 16, wherein the content provider authenticates the first subscriber by communicating the identifying information to a service provider of the first subscriber.

18. The computer usable program product of claim 14, wherein the computer usable code is stored in a computer readable storage medium in a data processing system, and wherein the computer usable code is transferred over a network from a remote data processing system.

19. The computer usable program product of claim 14, wherein the computer usable code is stored in a computer readable storage medium in a server data processing system, and wherein the computer usable code is downloaded over a network to a remote data processing system for use in a computer readable storage medium associated with the remote data processing system.

20. A system for recording and sharing televised content, the data processing system comprising:
a storage device including a storage medium, wherein the storage device stores computer usable program code; and
a processor, wherein the processor executes the computer usable program code, and wherein the computer usable program code comprises:
computer usable code for selecting, at a first device associated with a first subscriber, the televised content;
computer usable code for determining that a second device associated with a second subscriber should be used for recording the televised content, wherein the first device and the second device are configured by a content provider to not share any recorded content;
computer usable code for sending, from the first device to the second device, a first request to record the televised content at the second device;
computer usable code for causing, responsive to the first request, the second device to create a recording of the televised content at the second device;
computer usable code for causing, responsive to the first request, the second device to grant the first subscriber access to the recording; and
computer usable code for receiving, at the first device, a transmission of the recording from the second device.
